(19) United States
(12) Patent Application Publication
(10) Pub. No.: US 2008/0289614 A1
(43) Pub. Date: Nov. 27, 2008

(54) All Weather Cooking System

(76) Inventor: Pedro Henrique Vieira Xavier Carradinha, Lisboa (PT)

Correspondence Address: WILMERHALE/BOSTON, 60 STATE STREET, BOSTON, MA, 02109, US

(21) Appl. No.: 11/994,094

(22) PCT Filed: Jun. 29, 2006
(86) PCT No.: PCT/PT2006/000016

§ 371 Date: Jul. 15, 2008

(30) Foreign Application Priority Data
Jun. 29, 2005 (PT) 103298

(51) Int. Cl. A47J 37/00

(52) U.S. Cl. 126/25 R

(57) ABSTRACT

This invention is related to a universal, multi-functional article, with application to camping stoves and is composed by a wind proof protection, which is placed around the stove burner, composed by a structure, open on the upper and lower sections. It can be suspended. It can be packaged for equipment transportation. It can be used as an oven.

### FIELD OF THE INVENTION

The present invention is related to a universal, multi-functional article to use in camping stoves.

### DESCRIPTION OF THE INVENTION

The present invention is related to a universal, multi-functional article, with application to camping stoves or cooking objects for camping, to function essentially as a wind barrier.

It is well known to the outdoor lovers, especially to those into hiking and trekking, the problems they face when cooking a hot meal in the open air. For these, the use of small portable stove/gas canister sets, which they carry with and quickly assemble, allowing a hot meal with some degree of independence of the place where they stay is familiar. These sets allow increasing the distance covered without a greater or minor dependence of the food preparation. One of the main problems of these sets is the fact that its use is dependent of the weather conditions. Thus, in rain or wind conditions, its use is practically impossible.

The present invention solves this problem, providing a cooking removable system to all types of weather, to adapt to camping-like stove/gas canister sets, characterized by comprising a protection, at least an inner metallic strip, at least 2 hoops, an upper hoop and a lower hoop, and stringers; wherein the protection enfolds the hoops, the metallic strip being placed in the inner part of the protection in contact therewith, the protection being essentially hollow and of cylindrical form. The areas that enfold the hoops define an upper opening for reception of the kitchen utensil and a lower opening for reception of the stove/canister set, respectively, the said stringers being fixed to the protection immediately above of the lower hoop enveloping.

This accessory can be adapted to various canister and stove diameters making this article of universal application. The use of this article allows heat preservation, allowing the use of this type of stove even in wind conditions and increasing the energetic efficiency of the equipment.

### DETAILED DESCRIPTION OF THE INVENTION

The following detailed description is presented with reference to Figures and preferred embodiments and should not be considered as a limitation on the scope of the invention. It will be appreciated by the skilled person in the art, having the knowledge herein disclosured, that may conceive other embodiments without, however, departing from the scope of this invention as claimed in the attached claims.

The Figures show:

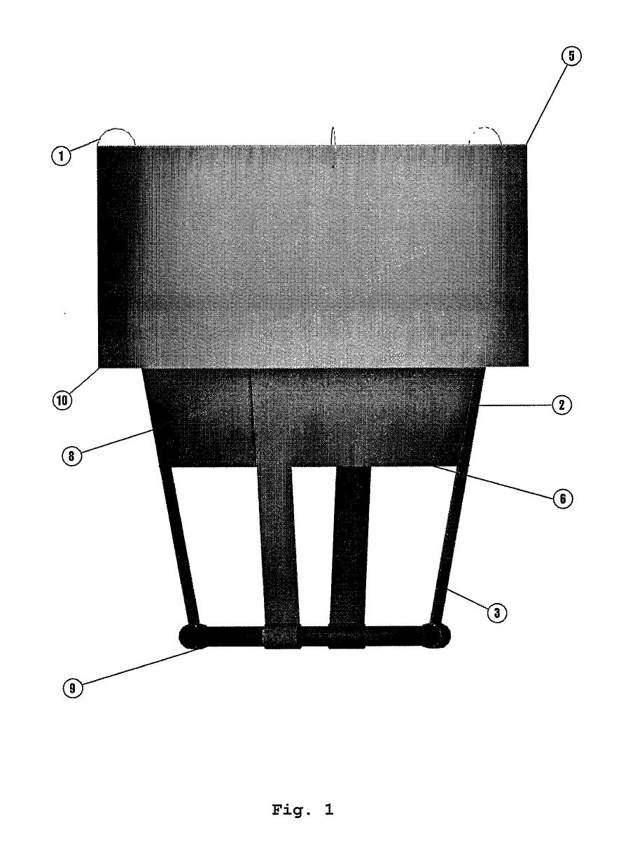

FIG. 1 is the side view of a preferred embodiment of the article for use not suspended;

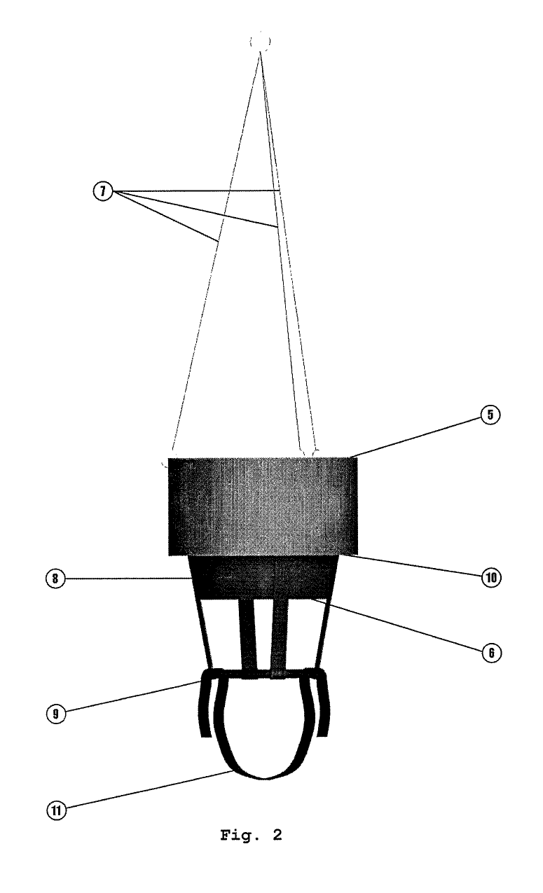

FIG. 2 is the side view of a preferred embodiment of the article, suspended and with removable fixing means (11) of previous section;

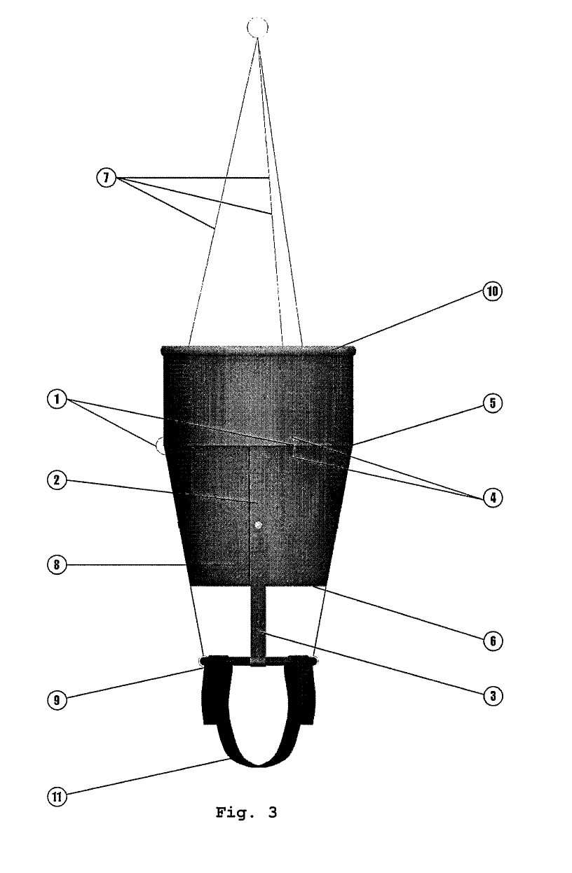

FIG. 3 is the side view of a preferred embodiment of the suspended article, with a protection (8) raising above the upper hoop (5);

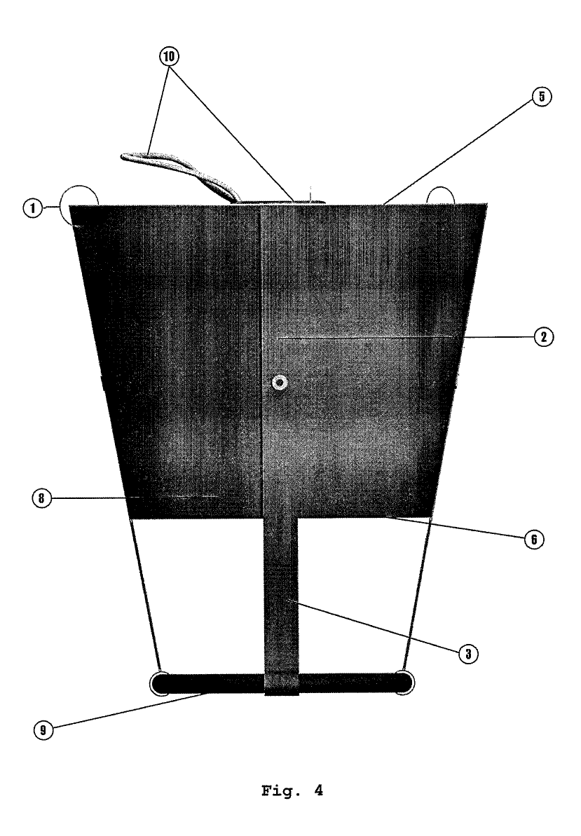

FIG. 4 is the side view of a preferred embodiment of the article, not suspended, with the latch system (10) in oven position;

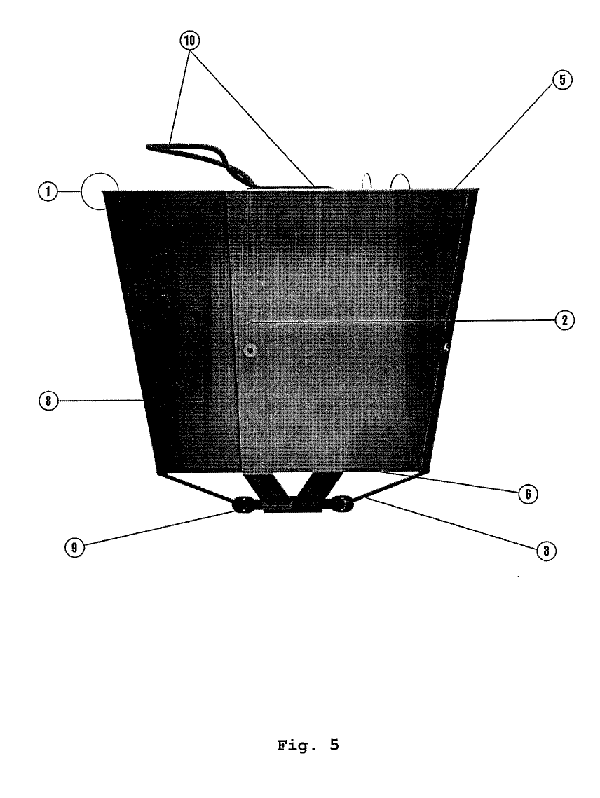

FIG. 5 is the side view of the preferred embodiment of FIG. 4, with the latch system (10) in closed position, and the stringers (3) lowered, like a package for transportation;

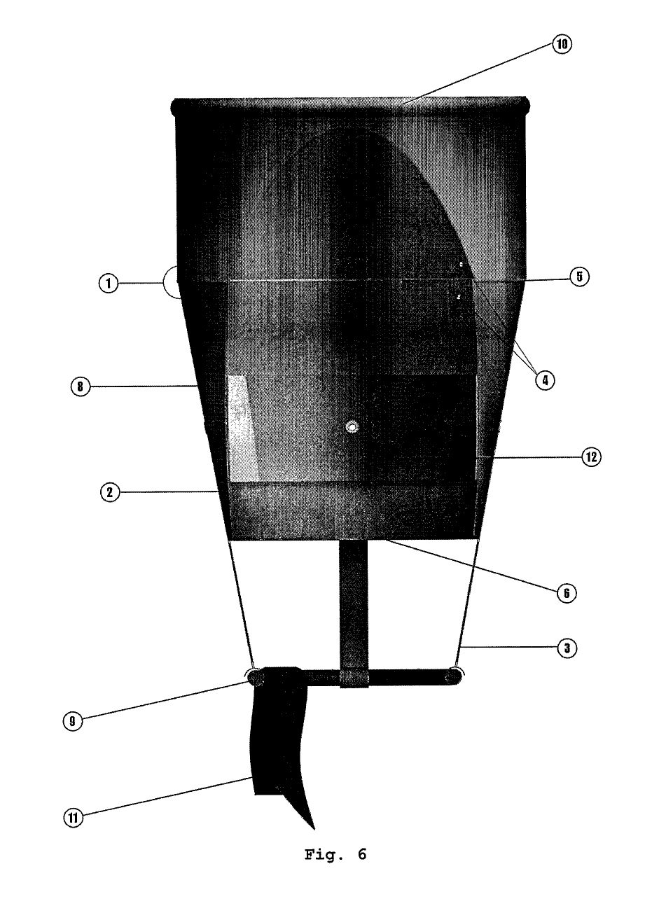

FIG. 6 is the inner view of the preferred embodiment of the article of FIG. 3, where the heat retention/reflection system (12) can be observed;

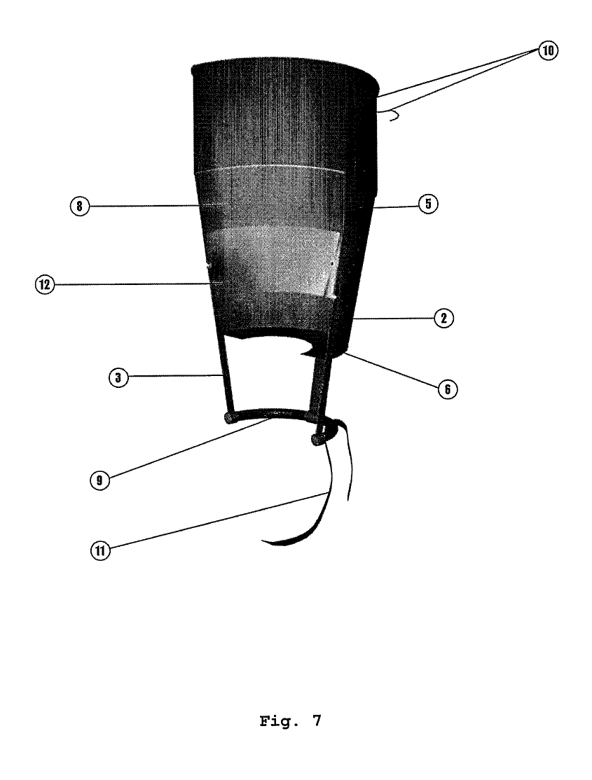

FIG. 7 is a cross section view of another preferred embodiment of the article;

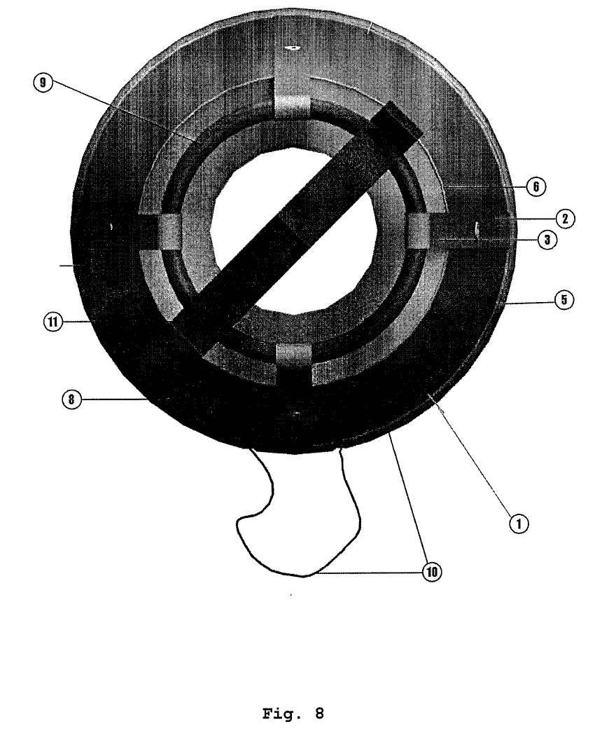

FIG. 8 is the bottom view of the preferred embodiment of the article of FIG. 7;

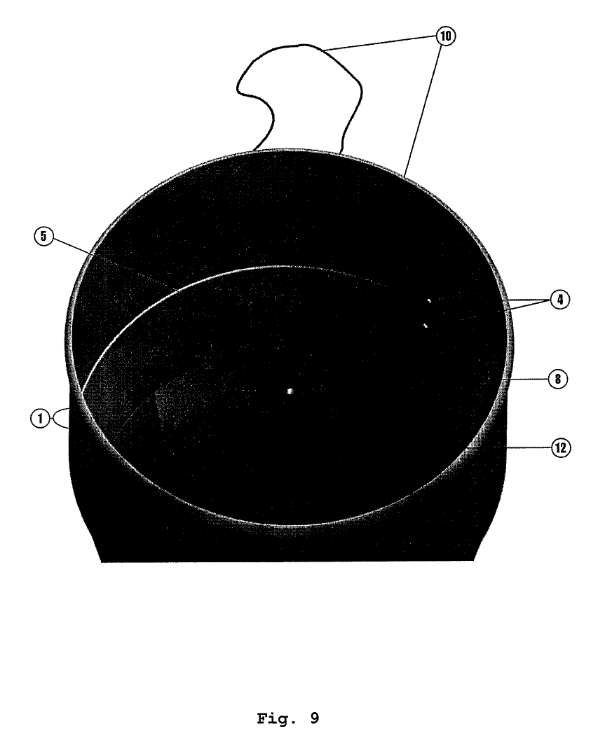

FIG. 9 is a top and inner view of the preferred embodiment of the article of FIG. 3, where the fixing places of the heat retention/reflection system (12) to the wind proof/anti-fire protection (8), as well as the ring fixing (1) holes (4) can be observed;

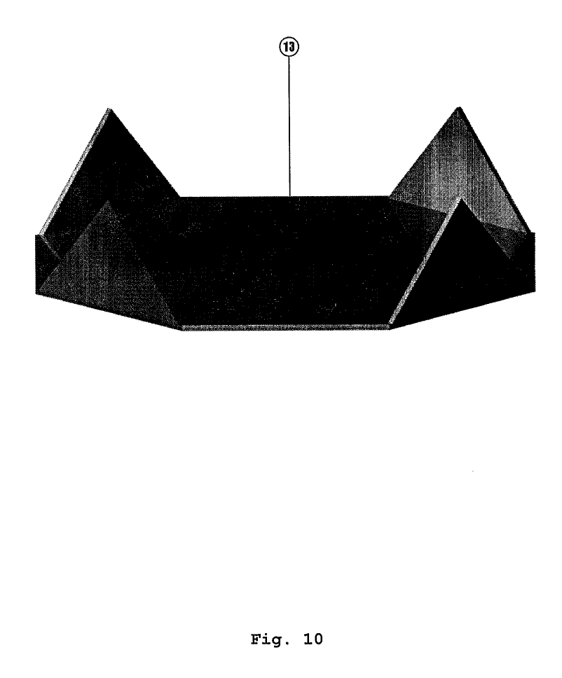

FIG. 10 is a perspective drawing of the separating part to use in oven position;

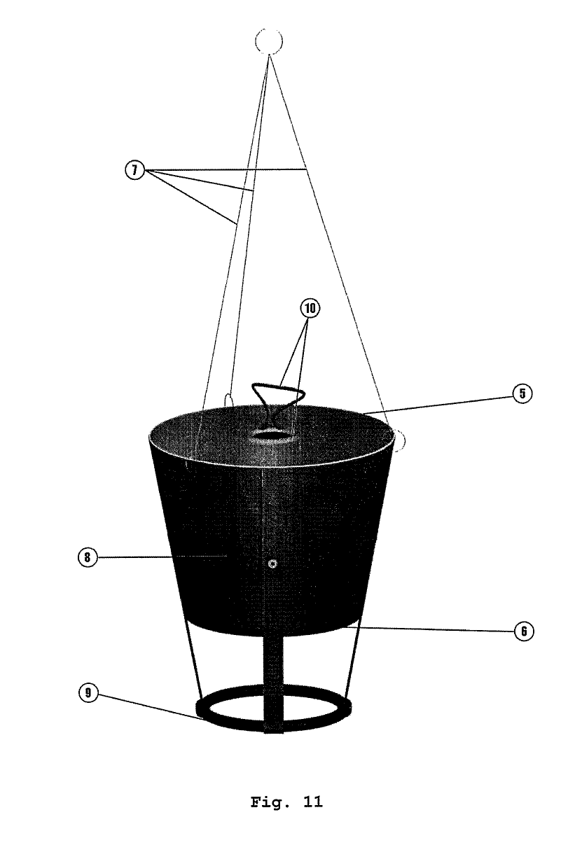

FIG. 11 is a side view of a preferred embodiment of the article, suspended, with the latch system (10) in oven position;

In a preferred embodiment of the present invention, the cooking accessory to all types of weather, is composed by an upper hoop (5), a lower hoop (6) and a protection that extends from the lower hoop (6) exceeding the upper hoop (5). There are four stringers (3) fixed to the protection (8), at least immediately above of the lower hoop, and extending beyond this. The protection (8) has an essentially cylindrical form, defined by the geometry of the hoops, and is hollow, with the areas that enfold the hoops defining an upper opening for reception of the kitchen utensil and a lower opening for reception of the stove/canister set and air inlet (oxygen in order to feed the burner), respectively. In FIG. 1, the protection (8) extends further beyond the upper hoop, the said protection being downfolded, directed towards the lower opening. The stringers have an adjustment system (9) that functions as a fixing means for fixing of the stove/canister set. Preferably, this adjustment system is made of a resilient material, most preferably, an elastic ribbon which is tighten up around the canister of the stove/canister set and that it is fixed in any way, namely through a removable knot. There is a metallic strip (12) inside the protection and in contact therewith. This metallic strip can be removable or fixed by fixing means, preferably by, at least, one grommet. The metallic strip (12) functions as a heat retention/reflection system, and is placed at the level of the stove burner, in order to reflect the flame heat.

The protection of the present invention can be preferably made from any anti-fire insulating material, more preferably by a malleable anti-fire insulating material. Nomex®, provided by Dupont®, can be referred as an example of appropriate materials to function as protection.

FIG. 2 shows a view of another embodiment of the present invention, wherein the cooking accessory to all types of weather is suspended using 3 hanging chains, bound to the protection (8) by rings (1), which pass through holes (4) in the protection (8).

In addition to the fixing means consisting of the adjustment system (9), there is another fixing mean, consisting of a system (11) of removable fixing that is fixed to the adjustment system (9), in a position of double fixing, passing underneath the canister base of the stove/canister set. This system (11) of removable fixing can be made of any material that allows the fixing of any diameter canisters, preferably made from a Velcro® strap. However, it can have any other fixing form, for example, through male/female-type locking springs, disposed along the ribbon.

FIG. 3 shows a view of another embodiment of the present invention, wherein the cooking accessory to all types of weather is suspended, but showing now a position where the protection (8) extends beyond the upper hoop involving area, being provided with means (10) to open and close the opening of this end, conferring greater protection to the external elements. FIG. 6 is a sectional inner view of this same embodiment, where the inner metallic strip (12) can also be observed.

In FIG. 4 for the not suspended system and in FIG. 11 for the suspended system, the outer aspect of two other embodiments of the present invention can be observed, wherein the system functions as an oven by almost complete closure of the upper opening with the means (10) and placing the separating part (13), of anti-fire material, inside the protection (8) in order to be placed on the stove, in direct contact with this, avoiding the direct contact of the kitchen utensils with the flame of the stove burner. Preferably, this separating part (13) has the shape shown in FIG. 10, or any other shape that the person skilled in the art can deduce, based on its knowledge and having the teachings of the present invention. Preferably, the separating part (13) can be made of aluminium, stainless steel or other metallic alloys, preferably aluminium.

By means of the latch system (10), which is located on the top of the article and the lowering of the stringers (3), as shown in FIG. 5, all the equipment can be carried like a package, being also possible to store the stove/canister set inside.

FIG. 7 shows a sectional view of another embodiment of the present invention, wherein the protection (8) extends below the lower hoop (6) in order to create a smaller lower opening than the opening created by the hoop (6). FIG. 8 shows a view of the embodiment of FIG. 7 wherein that reduction of the lower opening can be observed in more detail. The removable fixing mean (11) is placed in the double fixing position.

For the use as oven, the cooking accessory to all types of weather, one will have to place the separating part (13) over the stove burner, to place on top of this the kitchen container and to drive the latch system (10) located on the top section. This separating part (13) will function as to prevent that the kitchen container receives heat by direct flame. The said part is in contact with the flame and has embossed work in order to create space, so that the kitchen container receives heat in a homogeneous way.

The fixing of the rings (1) to the protection (8) is made through two holes (4) divided by the upper hoop (5), that allows the latch mean (10) is placed in three positions: in the inner space of the hanging chains, allowing the use in the suspended oven mode; in the outer space of the hanging chains, raising the latch mean (10) to keep the heat with much wind, or lowering the latch mean.

1. Cooking removable system to all types of weather, to adapt to camping-like stove/gas canister sets, characterized by comprising a protection (8), at least an inner metallic strip (12), at least 2 hoops, an upper hoop (5) and a lower hoop (6), and stringers (3), wherein the protection (8) enfolds the hoops (5,6), the metallic strip being placed in the inner part of the protection (8) in contact therewith, the protection (8) being substantially hollow and of cylindrical form, with the areas that enfold the hoops defining an upper opening for reception of the kitchen utensil and a lower opening for reception of the stove/canister set, respectively, the said stringers (3) being fixed to the protection immediately above of the lower hoop enveloping.

2. Cooking removable system according to claim 1, characterized in that the protection (8) is composed of an anti-fire insulating material.

3. Cooking removable system according to claim 1, characterized in that the said anti-fire insulating material is malleable.

4. Cooking removable system according to claim 1, characterized in that the metallic strip (12) is fixed to the protection through fixing means.

5. Cooking removable system according to claim 1, characterized in that the fixing of the metallic strip to the protection (8) is made through at least one grommet.

6. Cooking removable system according to claim 1, characterized in that the protection (8) extends above the involving area of the upper hoop, being provided with means (10) to open and close the opening of this upper end of the protection (8).

7. Cooking removable system according to claim 1, characterized in that further comprising means of system suspension.

8. Cooking removable system according to claim 1, characterized in that the means of system suspension are composed of at least three holes (4) in the protection immediately below of the upper hoop (5) involving area for fixing in removable hanging chains (7).

9. Cooking removable system according to claim 1, characterized in that rings (1) are placed in the holes (4) to bind hanging chains (7) to the protection.

10. Cooking removable system according to claim 1, characterized in that further comprising fixing means to fix to the stove/canister set.

11. Cooking removable system according to claim 1, characterized in that the fixing means to the stove/canister set are composed by an adjustment system (9) that binds the lower ends of the stringers (3) and a removable fixing system (11) bound by one of its ends to the adjustment system (9), and being its other end provided with means that allow the fixing to the same removable fixing system, in order that in the double fixing position of the removable system, this passes underneath the canister of the stove/canister set.

12. Cooking removable system according to claim 1, characterized in that further comprising a separating part (13) of anti-fire material, placed inside the protection (8) and placed over the stove, in order to be in direct contact with the stove and preventing direct contact of kitchen utensils with the flame of the stove burner.
